(19) United States
(12) Patent Application Publication
(10) Pub. No.: US 2003/0155933 A1
(43) Pub. Date: Aug. 21, 2003

(54) Dielectric test structure and test method

(76) Inventors: Mu-Chun Wang, Hsinchu Hsien (TW); Shu-Wen Lin, Nantou Hsien (TW)

Correspondence Address: J.C. Patents, Inc., Suite 250, 4 Venture, Irvine, CA, 92618, US

(21) Appl. No.: 10/078,319

(22) Filed: Feb. 15, 2002

(51) Int. Cl. H01H 31/12

(52) U.S. Cl. 324/551

(57) ABSTRACT

A dielectric test structure formed over a dielectric layer. The test structure includes a first structure and a second structure. The first structure comprises a first liner pad, a second liner pad and a first conductive layer for connecting the first and the second liner pad. The second structure comprises a first section and a second section positioned symmetrically on each side of the first conductive layer but detached from the first conductive layer. The first section includes a second conductive layer parallel to the first conductive layer, a third liner pad and a third conductive layer for connecting the second conductive layer and the third liner pad. The second section includes a fourth conductive layer parallel to the first conductive layer, a fourth liner pad and a fifth conductive layer for connecting the fourth conductive layer and the fourth liner pad.

### BACKGROUND OF THE INVENTION

1. Field of Invention

The present invention relates to a dielectric test structure and a test method. More particularly, the present invention relates to a test structure and a test method for measuring thermal stress of a low dielectric constant dielectric layer between metallic interconnects.

2. Description of Related Art

As the fabrication of semiconductor devices proceeds into the deep sub-micron regime, copper together with a low dielectric constant material are used to form metallic interconnects. Copper is a suitable material because of its low electric resistance, low electromigration rate as well as ease of formation by electroplating or chemical vapor deposition.

Due to porosity, low thermal expansion and poor bonding relationship with an upper metallic layer for a dielectric layer inside a metallic interconnect structure, an intermediate dielectric layer with a higher dielectric constant is often formed between the low dielectric constant layer and the upper metallic layer. The intermediate dielectric layer serves as a buffer layer joining the lower dielectric constant dielectric layer and the upper metallic layer.

When a device undergoes reliability test or operates with a high electric current, intense electrical current flowing from the upper metallic layer to a conductive layer within the low dielectric constant dielectric layer may result in high metallic resistance and give rise to the production of considerable heat. Due to a difference in coefficient of thermal expansion (CTE) between the low dielectric constant material layer and the high dielectric constant material layer above and the poor thermal dissipation of the low dielectric constant material, the low dielectric constant material layer is often damaged by heat. Consequently, there is a rise in dielectric constant and a drop in efficiency. Furthermore, inter-layer leakage from the low dielectric constant layer may also increase due to thermal stress. A device affected by the aforementioned problems may have a larger resistance-capacitor (RC) delay resulting in a drop in operating speed.

Currently, there is no effective method for finding the influence of thermal stress of the low dielectric constant material layer upon electrical current leakage during reliability test or high current operation. As such, a maximum operation electrical current for the device is difficult to determine. Therefore, excess operation electrical current may damage the device.

Furthermore, in a wire-bonding process, pressure and ultrasonic vibration must be applied to the contact point on the bonding pad. Consequently, the area of the silicon chip under the bonding pad is subjected to a mechanical stress. Due to the vulnerability of copper wire and low dielectric constant material to mechanical stress, circuits are rarely formed in the low dielectric constant dielectric layer underneath the bonding pad.

In addition, the size of each silicon chip has being gradually reduced due to the maturity of deep sub-micron manufacturing technology. Since the low dielectric constant material layer underneath the bonding pads is precluded from forming any circuits, the percentage of silicon chip area suitable for forming integrated circuits is further reduced.

### SUMMARY OF THE INVENTION

Accordingly, one object of the present invention is to provide a dielectric test structure and a test method capable of finding a relationship between thermal stress on a low dielectric constant material layer and metallic resistance thereof, when an electrical current passes through a conductive layer within a metallic interconnect structure

Another object of the present invention is to provide a dielectric test structure and test method capable of finding a relationship between the thermal stress applied to a low dielectric constant dielectric layer and the inter-layer electrical current leakage therefrom in a metallic interconnection.

Still another object of the present invention is to provide a dielectric test structure and a test method capable of measuring the influence of mechanical stress applied to a low dielectric constant dielectric layer between metallic interconnects upon current leakage therefrom during wire bonding. Thereby, circuits can be formed underneath the bonding pads of a silicon chip as desired.

To achieve these and other advantages and in accordance with the purpose of the invention, as embodied and broadly described herein, the invention provides a dielectric test structure. The test structure is formed over a dielectric layer. The test structure includes a first structure and a second structure. The first structure comprises of a first liner pad, a second liner pad and a first conductive layer for connecting the first and the second liner pad. The second structure comprises a first section and a second section positioned symmetrically on each side of the first conductive layer but detached from the first conductive layer. The first section includes a second conductive layer parallel to the first conductive layer, a third liner pad and a third conductive layer for connecting the second conductive layer and the third liner pad. Similarly, the second section includes a fourth conductive layer parallel to the first conductive layer, a fourth liner pad and a fifth conductive layer for connecting the fourth conductive layer and the fourth liner pad.

This invention also provides a method of testing a dielectric layer. The method can be applied to a dielectric constant test structure. The test structure is formed over a first dielectric layer. The test structure includes a first structure and a second structure. The first structure comprises a first liner pad, a second liner pad and a first conductive layer for connecting the first and the second liner pad. The second structure comprises a first section and a second section positioned symmetrically on each side of the first conductive layer but detached from the first conductive layer. The first section includes a second conductive layer parallel to the first conductive layer, a third liner pad and a third conductive layer for connecting the second conductive layer and the third liner pad. Similarly, the second section includes a fourth conductive layer parallel to the first conductive layer, a fourth liner pad and a fifth conductive layer for connecting the fourth conductive layer and the fourth liner pad. When an electrical current passes through the first structure, voltages at the first liner pad and the second liner pad are measured. By means of the given electrical current and the measured voltage differential, metallic resistance of the first structure and thermal stress applied to the dielectric layer are found. Thereafter, a voltage differential is applied to the third liner pad and the fourth liner pad. The electrical current passing through the second structure is measured as an inter-layer electrical current leakage from the dielectric layer.

The present invention further provides a method of testing a dielectric layer, which can be applied to a dielectric test structure. The test structure is formed over a first dielectric layer. The test structure includes a first structure and a second structure. The first structure comprises of a first liner pad, a second liner pad and a first conductive layer for connecting the first and the second liner pad. The second structure comprises of a first section and a second section positioned symmetrically on each side of the first conductive layer but detached from the first conductive layer. The first section includes a second conductive layer parallel to the first conductive layer, a third liner pad and a third conductive layer for connecting the second conductive layer and the third liner pad. Similarly, the second section includes a fourth conductive layer parallel to the first conductive layer, a fourth liner pad and a fifth conductive layer for connecting the fourth conductive layer and the fourth liner pad. A second dielectric layer is formed over the test structure above the first dielectric layer. A metallic layer is formed over the second dielectric layer. The test method includes the following steps. A mechanical stress is applied to the metallic layer. A first electrical current passes through the first structure. A voltage differential is applied to the third liner pad and the fourth liner pad of the second structure. An electrical current flowing through the second structure is measured as inter-layer electrical current leakage from the first dielectric layer. Voltage between the first liner pad and the second liner pad of the first structure is measured. The electrical current and the voltage measured from the first structure are used to find the metallic resistance of the first structure.

Furthermore, by forming a plurality of test structures each having a different line width and line separation over the first dielectric layer, inter-layer electrical current leakage from the first dielectric layer or the metallic resistance of each test structure can be measured. Hence, the relationship between electrical current leakage and line separation as well as the relationship between metallic resistance and line width can be found.

The present invention facilitates to determine the metallic resistance of a conductive layer within a low dielectric constant dielectric layer and thermal stress applied to the low dielectric constant dielectric layer, which result from the flow of an electrical current through the conductive layer. Hence, the influence of thermal stress of the low dielectric constant material layer on the electrical current leakage during a reliability test or a high current operation can be found. Ultimately, an maximum operation electrical current for a device can be determined and rules for separating conductive lines can be set.

Moreover, the test method of the present invention determines the influence of the mechanical stress of the low dielectric constant dielectric layer upon inter-layer electrical current leakage, or upon the metallic resistance of the metallic wire within the dielectric layer. With the relationship between electrical current leakage and line separation as well as the relationship between the metallic resistance and a line width, reliable design rules may be established for forming circuits inside the low dielectric constant material underneath a bonding pad of a silicon chip.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic top view showing a dielectric test structure according to one preferred embodiment of the present invention;

FIG. 2 is a top view showing a circuit configuration for measuring the metallic resistance of conductive line within a low dielectric constant material using the dielectric test structure according to one preferred embodiment of the present invention;

FIG. 3 is a schematic top view showing a circuit configuration for measuring inter-layer electrical current leakage from a low dielectric constant dielectric layer by using the dielectric constant test structure according to one preferred embodiment of the present invention;

FIG. 4 is a schematic top view showing a circuit configuration for measuring inter-layer electrical current leakage from a low dielectric constant dielectric layer during wire bonding process by using a dielectric constant test structure according to another preferred embodiment of the present invention;

FIG. 5 is a cross-sectional view along line 11-II of FIG. 4; and

FIG. 6 is a top view showing a circuit configuration for measuring the metallic resistance of metallic wire within a low dielectric constant material during wire bonding process by using a dielectric constant test structure according to another preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

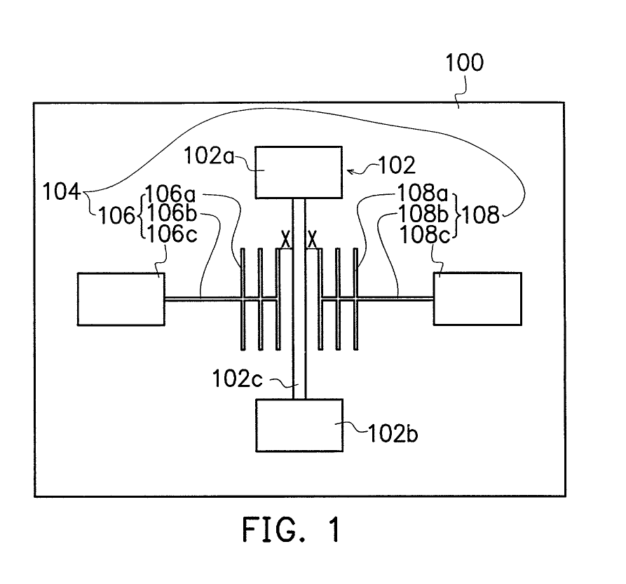

FIG. 1 is a schematic top view showing a dielectric test structure according to one preferred embodiment of this invention. The test structure is formed inside a low dielectric constant dielectric layer within a metallic interconnect structure. A dielectric layer having a higher dielectric constant is also formed over the low dielectric constant dielectric layer. Using the test structure of the present invention, metallic resistance of a conductive line within the low dielectric constant dielectric layer and inter-layer electrical current leakage from the low dielectric constant dielectric layer are measured. The test structure comprises a first structure 102 and a second structure 104.

As shown in FIG. 1, the first structure 102 is formed inside a dielectric layer 100. The first structure 102 comprises of a first liner pad 102a, a second liner pad 102b and a conductive layer 102c that links the first and the second liner pad together. The first structure 102 can be made of copper, for example.

Similarly, the second structure 104 is formed within the dielectric layer 100. The second structure 104 comprises a first section 106 and a second section 108. The first and the second section 106, 108 are on each side of the conductive layer 102c. The second structure 104 can be also made of copper, for example.

The first section 106 includes a first conductive layer 106a, a second conductive layer 106b and a liner pad 106c. The first section 106 is formed on one side of the conductive layer 102c with the first conductive layer 106a closest to the conductive layer 102c, the second conductive layer 106b further away and the liner pad 106c furthest from the conductive layer 102c. The conductive layer 106a is a conductive line parallel to the conductive layer 102c. The conductive layer 106b connects the conductive layer 106a to the liner pad 106c.

The second section 108 includes a first conductive layer 108a, a second conductive layer 108b and a liner pad 108c. The second section 108 is formed on the other side of the conductive layer 102c with the first conductive layer 108a closest to the conductive layer 102c, the second conductive layer 108b further away and the liner pad 108c furthest from the conductive layer 102c. The conductive layer 108a is a conductive line that runs parallel to the conductive layer 102c. The conductive layer 108b connects the conductive layer 108a and the liner pad 108c together.

The conductive layer 106a in the first section 106 and the conductive layer 108a in the second section 108 may have only one conductive line separated from the conductive layer 102c with a distance X. Distance X can be varied according to the test requirement. In FIG. 1, a plurality of conductive lines may be further provided used to enhance the resolution of the exposed pattern for the test structure, in particular, the position of the conductive layers 102c, 106a and 108a. Furthermore, the extra conductive lines may serve as dummy lines and prevent breakage of the main test line when the metallic layer undergoes a chemical-mechanical polishing operation.

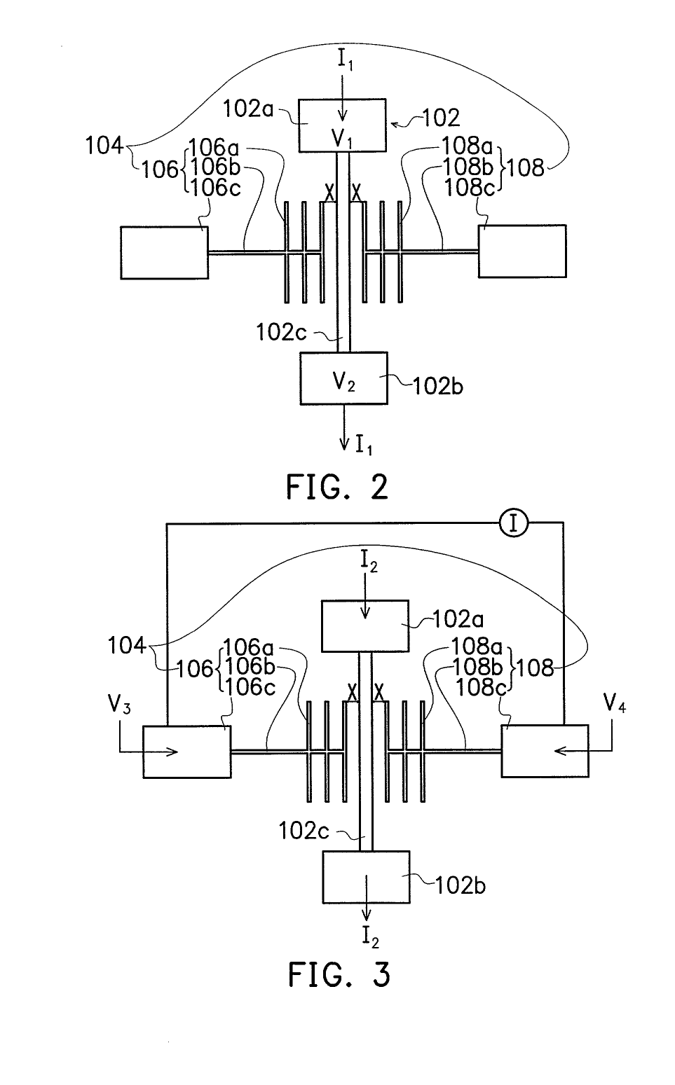

FIG. 2 is a top view showing a circuit configuration for measuring metallic resistance of a conductive layer within a low dielectric constant material by using the dielectric test structure according to one preferred embodiment of the present invention. First, an electrical current I₁ is applied to the first liner pad 102a and passes through the second liner pad 102b of the first structure 102. Voltage V₁ at liner pad 102a and voltage V₂ at liner pad 102b are measured. The measured voltages V₁ and V₂ as well as the input electrical current I₁ are put into the mathematical formula:

(V₁−V₂)/I₁=R (1)

Using the mathematical formula (1), the metallic resistance R of the conductive layer 102c within the low dielectric constant material layer 100 can be found.

With a given electrical current I₁ and a calculated metallic resistance R, power P generated when the current I₁ passes through the conductive layer 102c is obtained from the formula as follows:

P=I₁×R² (2)

After finding the power generated by the conductive layer 102c, temperature difference ΔT due to the power on the low dielectric constant dielectric layer 100 is given by the formula:

ΔT=thermal resistance×P (3),

wherein thermal resistance is that of the low dielectric constant dielectric layer 100.

Thus, using the value of the input electrical current I₁ through the first structure 102, metallic resistance R of the conductive layer 102c inside the low dielectric constant dielectric layer 100 and thermal stress on the low dielectric constant dielectric layer 100 can be found using formulae (1)˜(3).

FIG. 3 is a schematic top view showing a circuit configuration for measuring inter-layer electrical current leakage from a low dielectric constant dielectric layer, by using the dielectric constant test structure of this invention. First, an electric current I₂ is applied to the liner pad 102a and passes through the liner pad 102c of the first structure 102. A voltage V₃ is applied to the liner pad 106c on the left side of the second structure 104 and a voltage V₄ is applied to the liner pad 108c on the right side of the second structure 104. Any electrical current flowing through the second structure 104 is measured. An electrical current flowing through the second structure 104 indicates the electrical current 12 partially leaks out and passes through the first structure 102, which is referred to as inter-layer electrical current leakage. From the results of the measurement, the intensity of inter-layer electrical current leakage from the low dielectric constant dielectric layer 200 can be estimated.

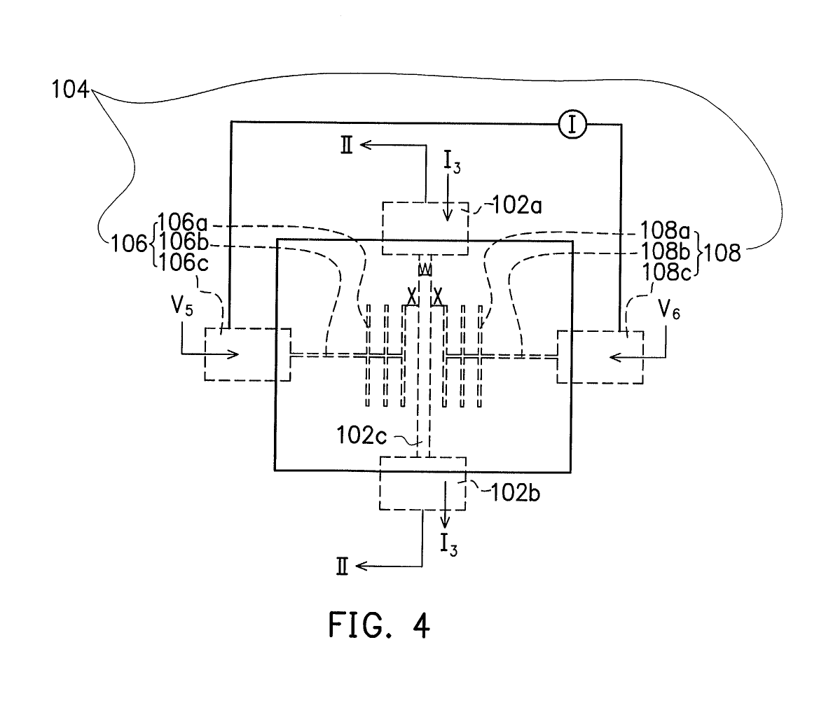

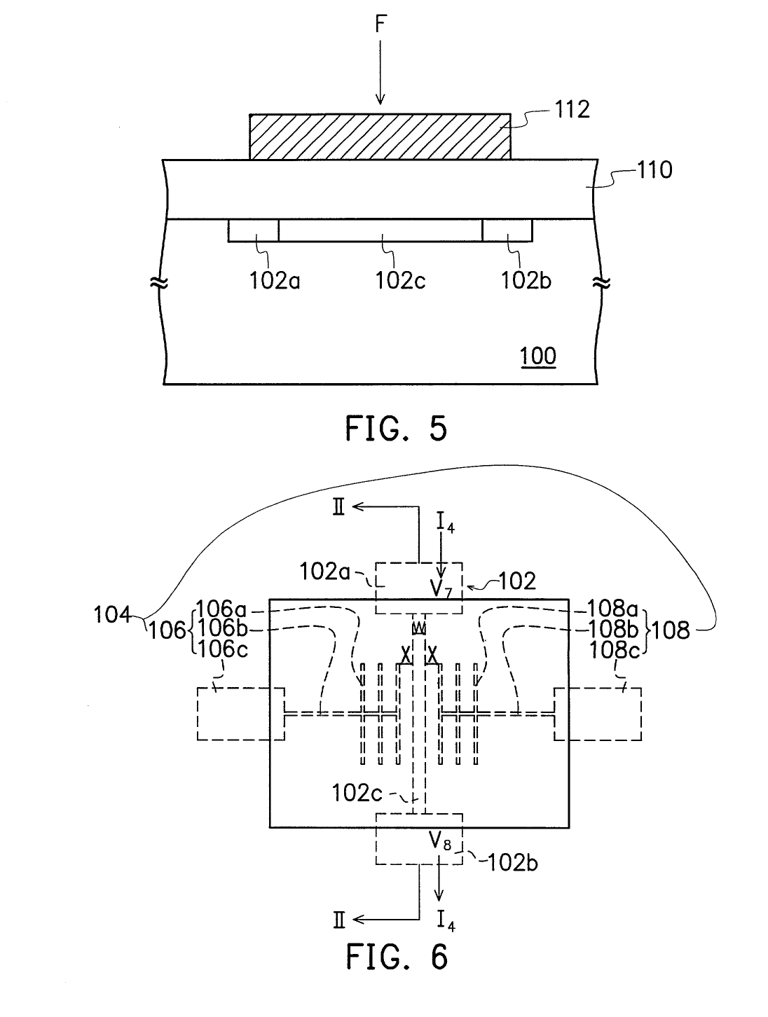

FIG. 4 is a schematic top view showing a circuit configuration for measuring inter-layer electrical current leakage from a low dielectric constant dielectric layer during wire bonding process by using the dielectric constant test structure according to another preferred embodiment of the present invention. FIG. 5 is a cross-sectional view along line II-II of FIG. 4. As shown in FIGS. 4 and 5, the method of the present invention can be applied to a dielectric test structure. A dielectric layer 110 is formed over the test structure that includes the dielectric layer 100, the first structure 102 and the second structure 104. Furthermore, a metallic layer 112 is formed over the dielectric layer 110. The metallic layer 112 represents a bonding pad over the silicon chip. To conduct a test, a mechanic force F is applied to the surface of the metallic layer 112. The mechanic force F, for example, simulates the actual force produced in a wire-bonding operation. An electrical current I₃ is applied to the liner pad 102a and passes the liner pad 102b of the first structure 102. The electrical current I₃, for example, is a value used for device operation. Voltages V₅ and V₆ are applied to the liner pad 106c and the liner pad 108c of the second structure 104, respectively. Any electrical current flowing through the second structure 104 is determined and the intensity of that electrical current is also measured.

The aforementioned test method can be used to find a relationship between inter-layer electrical current leakage and separation of conductive lines due to the mechanical stress during wire bonding process. The parameters including the mechanic force and electrical current I₃ are set and test structures having different conductive line separation distances X are formed over the dielectric layer 100. Thereafter, inter-layer electrical current leakage is determined for each of those test structures.

FIG. 6 is a top view showing a circuit configuration for measuring the metallic resistance of metallic wire within a low dielectric constant material due to wire bonding by using the dielectric test structure according to another preferred embodiment of the present invention. FIG. 5 is a cross-sectional view along line 11-11 of FIG. 6. As shown in FIGS. 5 and 6, a mechanic force F is applied to the metallic layer 112. The mechanic force F, for example, can be a value used for wire bonding. An electrical current I₄ is applied to the liner pad 102a and passes through the liner pad 102b of the first structure 102. The electrical current I₄ can be a value used for device operation, for example. Voltages V₇ and V₈ at the liner pad 102a and the liner pad 102b of the first structure 102 are measured, respectively. By putting the measured values into the mathematical formula (V₇−V₈)/I₄, metallic resistance R of the conductive layer 102c within the dielectric layer 100 is found.

Similarly, the aforementioned test method can be used to find a relationship between line width and metallic resistance of metallic wire subject to mechanical stress during wire bonding process. The parameters including the mechanic force F and electrical current I₄ are set and test structures having conductive lines of different line widths W are formed over the dielectric layer 100. Resistance values are obtained by calculation using the measured voltage values.

After a series of tests are made to obtain the relationship between line separation and inter-layer electrical current leakage and the relationship between line width and metallic resistance for an interconnection, minimum line width for a circuit to form underneath a bonding pad, where wire bonding stress can be endured, can be determined.

In view of foregoing, the test structure and test method of the present invention is able to determine metallic resistance of the conductive layer within a low dielectric constant material layer and estimate the thermal stress on the low dielectric constant material layer. Hence, maximum electrical current for reliability test and device operation can be set and related circuit design guidelines can be obtained. Moreover, by measuring the inter-layer electrical current leakage from the low dielectric constant dielectric layer, rules governing distance of separation between conductive lines can be established. With a better understanding of the thermal properties of the low dielectric constant material layer inside a metallic interconnect structure, inappropriate or excess operation electrical current is avoided and the performance of a semiconductor device is thus enhanced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A dielectric test structure formed over a dielectric layer, comprising:
a first structure having:
a first liner pad;
a second liner pad; and
a first conductive layer connecting the first liner pad and the second liner pad; and
a second structure having a first section and a second section, wherein the first section and the second section are on the respective sides of the first conductive layer,
the first section including:
a third liner pad;
a second conductive layer parallel to the first conductive layer between the third liner pad and the first conductive layer of the first structure; and
a third conductive layer connecting the second conductive layer and the third liner pad;
the second section including:
a fourth liner pad;
a fourth conductive layer parallel to the first conductive layer between the fourth liner pad and the first conductive layer of the first structure; and
a fifth conductive layer connecting the fourth conductive layer and the fourth liner pad.

2. The test structure of claim 1, wherein the second conductive layer is formed at a short distance away from the first conductive layer.

3. The test structure of claim 1, wherein the fourth conductive layer is formed at a short distance away from the first conductive layer.

4. The test structure of claim 1, wherein the second conductive layer further includes a plurality of conductive lines parallel to the first conductive layer.

5. The test structure of claim 1, wherein the fourth conductive layer further includes a plurality of conductive lines parallel to the first conductive layer.

6. The test structure of claim 1, wherein material constituting the first structure includes copper.

7. The test structure of claim 1, wherein material constituting the second structure includes copper.

8. A test method for a dielectric layer having a dielectric test structure thereon, wherein the dielectric test structure comprises a first structure and a second structure; the first structure includes a first liner pad, a second liner pad and a first conductive layer connecting the first liner pad and the second liner pad; the second structure includes a first section and a second section, the first section comprises a third liner pad, a second conductive layer parallel to the first conductive layer between the third liner pad and the first conductive layer of the first structure and a third conductive layer connecting the second conductive layer and the third liner pad, the second section comprises a fourth liner pad, a fourth conductive layer parallel to the first conductive layer between the fourth liner pad and the first conductive layer of the first structure and a fifth conductive layer connecting the fourth conductive layer and the fourth liner pad, the method comprising the steps of:
passing an electrical current into the first structure; and
measuring the voltage at the first liner pad and the voltage at the second liner pad and finding metallic resistance of the first structure using the value of the electrical current and the measured voltages.

9. The method of claim 8, wherein after the step of finding the metallic resistance of the first structure, further includes finding thermal stress applied to the dielectric layer using the values of the metallic resistance, the electrical current and thermal resistance of the dielectric layer.

10. The method of claim 8, wherein the method further includes the steps of applying a voltage between the third liner pad and the fourth liner pad and determining the electrical current passing through the second structure as inter-layer electrical current leakage from the dielectric layer.

11. The method of claim 8, wherein material constituting the first structure includes copper.

12. The method of claim 8, wherein material constituting the second structure includes copper.

13. A method of testing a dielectric layer using a dielectric test structure formed over a first dielectric layer, wherein the test structure includes a first structure and a second structure having a first section and a second section, the first structure includes a first liner pad, a second liner pad and a first conductive layer connecting the first and the second liner pad, the first section and the second section of the second structure are on each side of the first conductive layer, the first section further includes a third liner pad, a second conductive layer parallel to the first conductive layer between the third liner pad and the first conductive layer of the first structure and a third conductive layer connecting the second conductive layer and the third liner pad, the second section further includes a fourth liner pad, a fourth conductive layer parallel to the first conductive layer between the fourth liner pad and the first conductive layer of the first structure, and a fifth conductive layer connecting the fourth conductive layer and the fourth liner pad, the test structure further includes a second dielectric layer over the first dielectric layer and a metallic layer over the second dielectric layer, the method comprising the steps of:
applying a mechanical force to the metallic layer;
feeding a first electrical current through the first structure;
providing a voltage differential between the third liner pad and the fourth liner pad of the second structure;
determining a second electrical current flowing through the second structure to obtain intensity of inter-layer electrical current leaked from the first dielectric layer; and
measuring a first voltage at the first liner pad and a second voltage at the second liner pad of the first structure so that metallic resistance of the first structure can be found using the difference between the first and second voltage and the measured first electrical current.

14. The method of claim 13, wherein test structures having different metallic interconnect line widths are formed over the first dielectric layer.

15. The method of claim 13, wherein the method further includes the step of finding the metallic resistance of all different metallic interconnects each with a different line width.

16. The method of claim 13, wherein test structures with metallic interconnects at different distance of separation from the first conductive layer are formed over the first dielectric layer.

17. The method of claim 13, wherein the method further includes the step of measuring inter-layer electrical current leaked from the first dielectric layer for each of the test structures having different separation distance between the metallic interconnect and the first conductive layer.

18. The method of claim 13, wherein material used to form the first structure includes copper.

19. The method of claim 13, wherein material constituting the second structure includes copper.
